(19) United States
(12) Patent Application Publication
(10) Pub. No.: US 2026/0196117 A1
(43) Pub. Date: Jul. 9, 2026

(54) NEAR-FIELD INTRUSION DETECTION AND DETERRENCE FOR A MOBILE SECURITY UNIT

(71) Applicant: LiveView Technologies, LLC, American Fork, UT (US)

(72) Inventors: James P. BANGERTER, Saratoga Springs, UT (US); Dustin M. ARGYLE, American Fork, UT (US); Paul J. ANDRUS, American Fork, UT (US)

(21) Appl. No.: 19/418,180

(22) Filed: Dec. 12, 2025

Related U.S. Application Data
(60) Provisional application No. 63/741,663, filed on Jan. 3, 2025.

(51) Int. Cl. G08B 13/196

(52) U.S. Cl. CPC G08B 13/19608; G08B 13/19626; G08B 13/19652

(57) ABSTRACT

This disclosure describes an intrusion detection system for a mobile security unit (MSU) that prevents tampering with the unit by accurately detecting and responding to intrusion and tampering threats. For example, the intrusion detection system utilizes a thermal video stream from the MSU and computer vision techniques to autonomously determine when moving objects are credible threats to the unit while minimizing false positives. Additionally, the intrusion detection system can cause the unit to trigger a response to ward off potential threats. Indeed, the intrusion detection system can utilize a combination of thermal imaging, computer vision, and machine learning models to accurately identify, classify, and respond to escalating levels of threats against an MSU.

### CROSS-REFERENCE TO RELATED APPLICATIONS

This application claims benefit and priority to Provisional Application Number 63/741,663, titled NEAR-FIELD DETECTION AND DETERRENCE FOR A MOBILE UNIT, and filed on Jan. 3, 2025, the entirety of which is incorporated herein by reference.

### BACKGROUND

Recent years have witnessed significant growth in both hardware and software within the field of mobile security. A prime example of these advancements is mobile security units (MSUs). These portable, versatile, and autonomous surveillance devices are equipped with a range of cameras, sensors, and technologies to detect and respond to potential threats. MSUs can be deployed across diverse environments to provide on-demand security monitoring and deterrence.

However, with the increased deployment of MSUs comes a heightened need to detect and prevent tampering with these devices. This task is challenging due to the variety of environments in which MSUs operate, from crowded parking lots to remote construction sites. Current hardware and software solutions, which include various types of cameras and sensors, often fail to reliably detect credible tampering threats. Additionally, these solutions frequently generate false positives, especially in areas where people and vehicles frequently pass close to a unit. False positives waste computing resources, unit power, and bandwidth by reporting non-threatening incidents. These false alarms not only reduce the effectiveness of the unit but can also cause MSUs to become a nuisance.

These challenges highlight the need for more effective and intelligent solutions to enhance the reliability and accuracy of MSU tampering detection and deterrence across various deployment scenarios.

### BRIEF DESCRIPTION OF THE DRAWINGS

The following detailed description provides specific implementations accompanied by drawings. Additionally, each of the figures listed below corresponds to one or more implementations discussed in this disclosure.

FIGS. 1A-1B illustrate a mobile unit that includes hardware and software components, such as an intrusion detection system, for detecting and preventing tampering with the mobile unit.

FIG. 2 illustrates an example computing environment in which an intrusion detection system is implemented.

FIG. 3 illustrates an example flow diagram for detecting and preventing tampering with a mobile unit.

FIG. 4 illustrates an example flow diagram for detecting escalating intrusion and tampering threats to a mobile unit.

FIGS. 5A-5B illustrate an example thermal video frame from a thermal video stream that includes monitoring zones.

FIGS. 6A-6D illustrate thermal video frames from a thermal video stream of a detected person within an alert zone associated with the mobile unit.

FIG. 7 illustrates an example series of acts in a computer-implemented method for determining proximity threats to mobile security units (MSUs).

FIG. 8 illustrates example components included within a computer system for implementing an intrusion detection system.

### DETAILED DESCRIPTION

This disclosure describes an intrusion detection system for a mobile security unit (MSU) that prevents tampering with the unit by accurately detecting and responding to intrusion and tampering threats. For example, the intrusion detection system utilizes a thermal video stream from the MSU and computer vision techniques to autonomously determine when moving objects are credible threats to the unit while minimizing false positives. Additionally, the intrusion detection system can cause the unit to trigger a response to ward off potential threats. Indeed, the intrusion detection system can utilize a combination of thermal imaging, computer vision, and machine learning models to accurately identify, classify, and respond to escalating levels of threats against an MSU.

For instance, in one or more implementations, the intrusion detection system determines proximity threats to one or more mobile security units (MSUs) by receiving a thermal video stream captured from a thermal camera mounted near the end of a mast of an MSU, where the thermal video stream provides a downward-looking view of the MSU. The intrusion detection system may detect a moving object within an alert zone of the thermal video stream and, in response, update a set of tracking parameters associated with the moving object. The intrusion detection system may also compare the set of tracking parameters to a set of alert conditions to determine when an alert threshold is met. Based on the alert threshold being met, the intrusion detection system may send an alert indication to an alert system to activate a set of alarm responses at the MSU.

As mentioned above, many MSUs are deployed in highly trafficked areas, such as retail parking lots, where it is common to have people and vehicles in close proximity to the unit. This often results in false positive alerts that negatively impact the effectiveness of the units. Other deployments of MSUs are in isolated areas where any traffic should trigger a deterrent response from the system. In addition to providing security and surveillance functions, MSUs need to accurately detect threats to the units themselves, such as unauthorized contact or tampering.

Many prior attempts to solve the problem of unit tampering have included passive motion detection, Doppler radar arrays, and ultrasonic rangefinders. However, while these sensors can detect when objects are near a unit, they are severely limited in their ability to provide insight into the threat credibility of a detected object and frequently cause false alerts. Additionally, these approaches require large numbers of sensors to provide 360-degree coverage around a unit, which increases the complexity and costs of the units, as well as the processing power required to analyze the data from the sensors.

Some MSUs use visible spectrum cameras. These cameras, however, face several limitations that make them ineffective. For example, visible spectrum cameras perform poorly in low-light conditions, which is when unit tampering is most likely to occur. Additionally, many MSUs include constant flashing lights as a security tool to deter malicious activity at the location where the MSU is deployed. However, flashing lights can obstruct images captured by visible spectrum cameras and trigger false alerts, preventing visible spectrum cameras from being a feasible solution.

As mentioned above, the intrusion detection system on an MSU solves these and other technical and practical problems with current systems and approaches that address unit intrusion and tampering. Indeed, implementations of the present disclosure provide benefits and solve various problems in the art with systems, devices, computer-readable media, and computer-implemented methods that allow for accurately determining credible threats to MSUs while minimizing false positive alerts. In particular, the intrusion detection system can utilize a combination of thermal imaging, computer vision, and machine learning models to accurately identify, classify, and respond to escalating levels of threats against an MSU.

To elaborate, in various implementations, an MSU includes a thermal camera (e.g., a long-wave infrared (LWIR) camera and/or a Lepton camera) mounted near the top end of a pole or a mast extending above the MSU. The thermal camera provides a downward-looking thermal (e.g., infrared) video stream with images of the MSU and the immediate surrounding areas. In some implementations, the thermal camera is a mid-wave infrared (MWIR) camera. In some implementations, the thermal camera is a non-infrared camera that captures thermal data about the captured environment.

The intrusion detection system utilizes computer vision (CV) and machine learning (ML) to identify and classify escalating levels of threats within alert zones in the thermal video stream. In some instances, the intrusion detection system uses an intelligent set of parameters, factors, and conditions to assess the threat levels of detected objects. By doing so, the intrusion detection system autonomously detects intrusions into unwanted spaces surrounding the unit. Furthermore, the intrusion detection system can cause the MSU to provide alerts, alarms, and other deterrents commensurate with the detected threat level.

Compared to current systems that utilize a sensor approach, the intrusion detection system provides several key technical advantages. For example, the intrusion detection system provides an adaptable solution that works across various types of environments and environmental conditions. The intrusion detection system significantly reduces the number of false positive alerts by utilizing tracking parameters and various alert condition sets (e.g., profiles) to determine when a threat is credible and the severity of the threat level.

Furthermore, the intrusion detection system requires lower power consumption and computational complexity by significantly reducing the number of components to one or two thermal cameras. This, in turn, results in low computational requirements to detect unit tampering. The intrusion detection system also provides continuous detection independent of lighting or other environmental conditions, as thermal imaging is not affected by lighting conditions (e.g., the intrusion detection system detects the correct signals while ignoring noise such as low lighting, over-lighting, or flashing lights). In addition, the intrusion detection system can operate with both low-resolution and high-resolution thermal video streams.

Although various implementations are described in this document with reference to security systems, surveillance systems, mobile security, and/or mobile surveillance units, the present disclosure is not limited to only these applications. In various implementations, the intrusion detection system may be generally applicable to any system, device, and/or unit that may include security and/or surveillance systems. Furthermore, although some implementations are disclosed with reference to a mobile unit, the disclosure equally applies to stationary units (e.g., stationary security/surveillance devices), such as a unit coupled to a stationary pole (e.g., a light pole), a structure (e.g., a business or residence), a tree, or another stationary object that enables a thermal camera to be mounted near the top for a downward-looking view.

As illustrated in the foregoing discussion, this disclosure utilizes a variety of example terms to describe the features and advantages of one or more implementations. For instance, this disclosure describes the intrusion detection system in the context of a mobile unit. In this document, a “mobile unit” (including a “mobile security unit” or “mobile surveillance unit”) refers to a security and/or surveillance system, device, or set of devices that form a cohesive unit to surveil a designated area. For example, a mobile unit may be a security trailer or other portable device with surveillance components (e.g., cameras, lights, measurement sensors) and computational components for capturing, storing, processing, and/or providing surveillance data at a deployed location. In some implementations, a mobile unit includes alert or output components (e.g., lights, speakers, sirens) for deterring malicious actions at the deployed location or against the mobile unit. The abbreviation “MSU” may refer to a mobile security unit, which can include a mobile surveillance unit. Additional information about mobile units is provided below in connection with the figures.

In addition, the term “machine-learning model” refers to a computer model or computer representation that can be trained (e.g., optimized) based on inputs to approximate unknown functions. For instance, a machine-learning model can include (but is not limited to) an autoencoder model, an embedding model, a classification model, a neural network, a decision tree (e.g., a gradient-boosted decision tree), a linear regression model, a logistic regression model, or a combination of these models.

As another example, the term “neural network” refers to a machine learning model made up of interconnected artificial neurons that communicate and learn to approximate complex functions. Neural networks generate outputs based on multiple inputs provided to the model. For instance, a neural network includes an algorithm (or set of algorithms) that uses deep learning techniques and training data to adjust the parameters of the network and model high-level abstractions in data. Compared to generative artificial intelligence (AI) models, machine learning models and neural networks use fewer parameters and are more computationally efficient. There are various types of neural networks, including transformer-based neural networks, convolutional neural networks (CNNs), embedding neural networks, residual learning neural networks, recurrent neural networks (RNNs), generative neural networks, generative adversarial networks (GANs), and single-shot detection (SSD) networks.

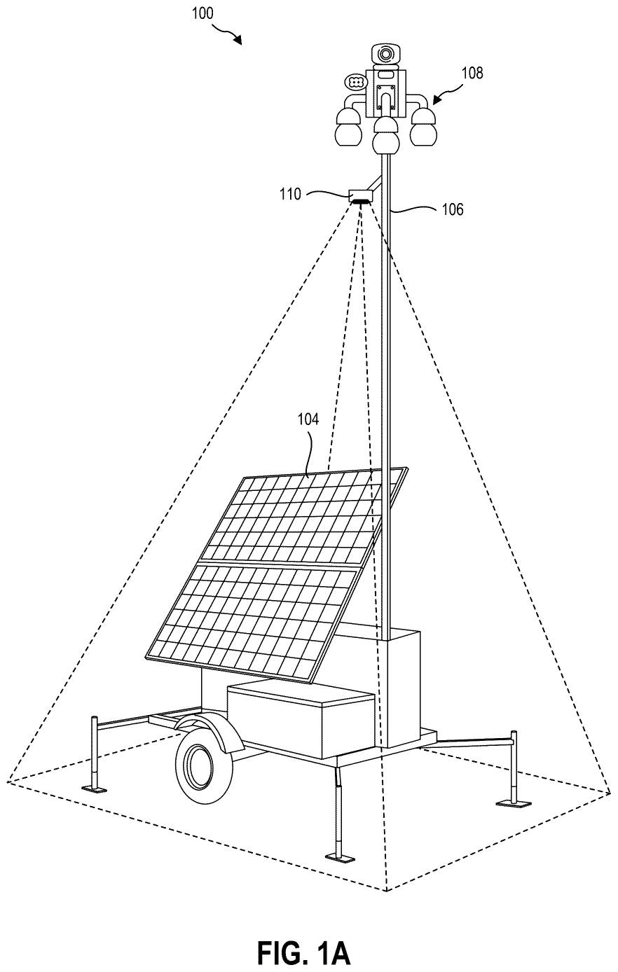

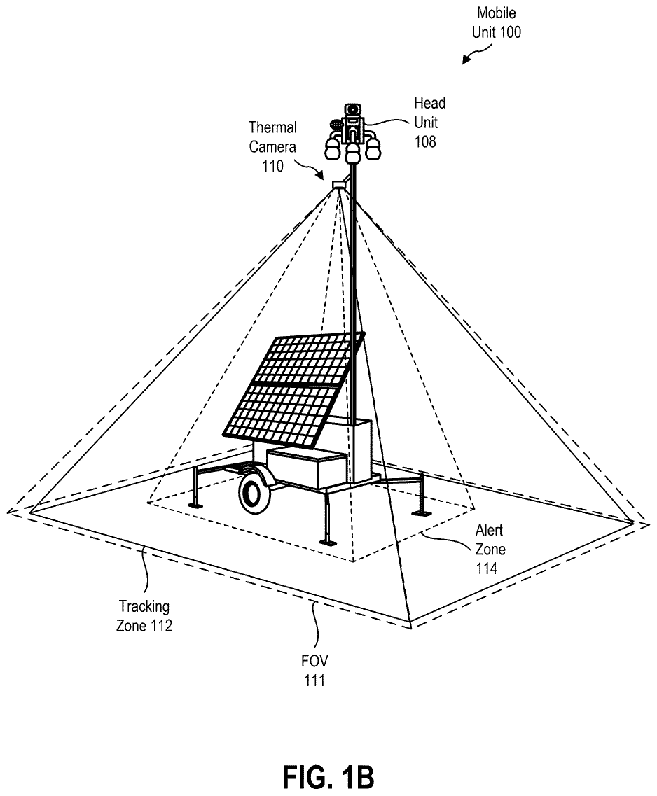

Additional example implementations and details of the intrusion detection system are discussed in connection with the accompanying figures, which are described next. For example, FIGS. 1A-1B illustrate a mobile unit that includes hardware and software components, such as an intrusion detection system, for detecting and preventing tampering with the mobile unit according to some implementations. For example, FIG. 1A shows a mobile unit (e.g., an MSU) with a thermal camera, and FIG. 1B shows the thermal camera capturing monitoring zones using the thermal camera.

As mentioned, FIG. 1A includes a mobile unit 100, which may represent a mobile security unit, which can include a mobile surveillance unit. The mobile unit 100 includes base components 102, a power system 104, a mast 106 (or pole), a head unit 108, and a thermal camera 110. The mobile unit 100 may include additional and/or different components, units, or systems.

In various implementations, the base components 102 include a trailer system for transporting the unit and protected compartments for storing parts of the unit during transport. In some instances, the base components 102 include one or more sensors or other data-capturing devices.

The power system 104 may include solar panels and batteries. For example, the power system 104 includes primary and secondary batteries. In some implementations, the power system 104 includes one or more additional power sources, such as generators (e.g., fuel cell generators). In some instances, the power system 104 includes connections for hooking up to external power sources.

As shown, the mobile unit 100 includes a mast 106. In various instances, the mast 106 is an extendable pole that is retracted while the mobile unit 100 is being transported and extended once the unit is secured at its deployed location, such that the bottom edge extends upward from the base components 102. The mast 106 supports the head unit 108 and the thermal camera 110 attached at or near the top end. In various instances, the head unit 108 includes cords or cables for connecting components on the head unit 108 and/or the thermal camera 110 to the base components 102.

In various implementations, the head unit 108 may include one or more sensors, visible spectrum cameras, and processing components (e.g., computing devices) that capture, process, and store surveillance data. For example, the head unit 108 includes hardware and software computing elements that allow the mobile unit 100 to serve as an edge unit. In some instances, the head unit 108 also includes input and output components, such as one or more lights (e.g., flood lights, strobe lights, LED lights), speakers (e.g., one-way speakers or two-way public address (PA) speaker systems), microphones, display devices, and/or other suitable output devices. The head unit 108 may also include batteries or other power components. In various implementations, the head unit 108 may be referred to as a “live unit.”

In one or more implementations, some components located on the head unit 108 may also be located elsewhere on the mobile unit 100, such as in the base components 102. In some instances, the base components 102 may include backup or secondary components. For example, the base components 102 include processing components and/or backup processing components for the mobile unit 100.

In various implementations, the thermal camera 110 is associated with a mast mounting bracket, an enclosure, a carrier board, and a thermal camera module. For example, the thermal camera 110 (e.g., a thermal camera module) is attached to a carrier board (e.g., a circuit board with communication ports). In some instances, the term “thermal camera” refers to both the thermal camera module and the carrier board. The carrier board may be secured within an enclosure that surrounds and protects the thermal camera 110 from environmental elements and tampering. The carrier board may be secured to the enclosure via a camera mounting bracket. In some instances, foam or other padding is used to secure the thermal camera module and/or carrier board within the enclosure to provide resilience against movement and impacts. In various implementations, compressive foam is implemented in such a way that it does not block or clip the camera field of view. Furthermore, the enclosure may be fastened to the mast mounting bracket, which attaches to the mast 106.

In various implementations, the thermal camera 110 is a long-wave infrared (LWIR) camera, such as a Lepton LWIR micro thermal camera module (or another Lepton thermal camera). The mobile unit 100 operates in most outdoor conditions (e.g., the thermal camera, enclosure, and cabling are suitable for UV exposure, precipitation, humidity, and temperatures (such as from about −25° C. to about 50° C.)). For example, the enclosure includes a protective window (e.g., an IR window) that is compatible with LWIR wavelengths (8-12 micrometers) and allows for transmissivity above 75%.

In various implementations, the thermal camera 110 provides a low-resolution (e.g., 160×120 pixels) thermal video stream from the mobile unit 100. In some implementations, the resolution is higher, including high-definition, ultra-high-definition, or other higher resolutions.

As mentioned above, the thermal camera 110 may be mounted directly to the mast 106 (e.g., via a mast mounting bracket and enclosure). In particular, when mounted, the thermal camera 110 is oriented to be downward-facing to capture a top-down view of the mobile unit 100 and its surrounding area. In various implementations, the thermal camera 110 is offset (e.g., 6 inches, 1 foot, or 2 feet) from the mast 106 to provide a fuller field of view (FOV) while also ensuring mounting stability. Additionally, the thermal camera 110 may include cables (e.g., a USB cable) or other connection cords to connect the thermal camera 110 to the processing components at the head unit 108. In various implementations, the thermal camera 110 is included with, mounted on, and/or integrated into the head unit 108. The thermal camera 110 may be affixed to the mobile unit 100 in a way that does not obstruct the FOV of the visible spectrum cameras.

As shown, the thermal camera 110 captures thermal images within an FOV 111. In particular, the FOV 111 captures the mobile unit 100 and its surrounding areas. In various implementations, the FOV 111 is limited to the surrounding areas of the mobile unit 100, allowing the intrusion detection system to provide tamper protection against the unit without burdening the intrusion detection system with excessive coverage to monitor and/or process.

In some implementations, the FOV 111 includes a blind spot caused by the mast 106. For example, in some instances, the mast 106 causes a partial obstruction that allows the FOV to cover about 320° around the mobile unit 100. In some implementations, the thermal camera 110 provides varying levels FOV coverage. In some instances, the thermal camera 110 is positioned to minimize or eliminate blind spots and coverage loss. Additionally, while one thermal camera is included, in various instances, the mobile unit 100 includes multiple thermal cameras, such as two strategically placed cameras, to fully capture the area around the mobile unit 100 without any blind spots.

In various implementations, the intrusion detection system creates monitoring zones within the FOV 111. To illustrate, FIG. 1B shows the thermal camera 110 capturing monitoring zones using the thermal camera 110 according to some embodiments. As shown, FIG. 1B includes the mobile unit 100 with the head unit 108 and the thermal camera 110.

The thermal camera 110 captures a thermal video stream (e.g., IR video) based on the FOV 111. In various implementations, the intrusion detection system creates one or more monitoring zones within the FOV 111. For example, the intrusion detection system includes a tracking zone 112 and an alert zone 114 within the FOV 111. In various implementations, the FOV 111 includes additional and/or different zones. The intrusion detection system may create monitoring zones by imposing a digital fence or boundaries within the thermal video stream. For instance, the intrusion detection system uses a software solution to define the monitoring zones (in any shape or combination of shapes) within the thermal video stream.

In one or more implementations, the tracking zone 112 is used to capture and detect moving objects near the mobile unit 100. For example, the tracking zone 112 serves as an early warning system to determine when objects are approaching the mobile unit 100 and whether the objects should be monitored (e.g., whether the moving object is a person, animal, or another object). In various implementations, the tracking zone 112 aligns with the FOV 111. In some implementations, the tracking zone 112 is smaller than the FOV 111. In some implementations, the FOV 111 may not include the tracking zone 112.

As shown, the FOV 111 includes the alert zone 114. In various implementations, the alert zone 114 is located within the tracking zone 112. In particular, the alert zone 114 provides coverage for the immediate area surrounding the mobile unit 100. As further described below, the intrusion detection system may associate tracking parameters with persons detected within the alert zone 114 and update their corresponding tracking parameters based on the detected characteristics. As also described further below, the intrusion detection system may determine when a detected person within the alert zone 114 triggers one or more security profiles associated with unit tampering.

In various implementations, the alert zone 114 is located within or is encompassed by the tracking zone 112. In this way, the intrusion detection system can continue to monitor potential tampering threats even as they cross between the tracking zone 112 and the alert zone 114. In some implementations, the FOV 111 includes one or more additional specialty zones within the alert zone 114, as further described below.

With a general overview in place, the next figure provides an overview of example components, features, and elements of the intrusion detection system. To illustrate, FIG. 2 shows an example computing environment where the intrusion detection system is implemented in a cloud computing system according to some implementations. In particular, FIG. 2 shows an example of a computing environment 200 with various computing devices associated with an intrusion detection system 210. While FIG. 2 shows example arrangements and configurations of the computing environment 200, the mobile security unit 202, the intrusion detection system 210, and associated components, other arrangements and configurations are possible.

As shown, the computing environment 200 includes a mobile security unit 202 (e.g., a mobile surveillance unit), which may represent an instance of the mobile unit 100 introduced above. In some instances, the mobile security unit 202 is a different type of portable security unit designed to maintain surveillance at a deployed location. The mobile security unit 202 includes a computing device 204. The computing environment 200 also includes a cloud computing system 240 and a client device 250 connected to the mobile security unit 202 and/or computing device 204 via a network 260. Each of these units, systems, and/or components may be implemented on one or more computing devices, such as a set of one or more edge devices or server devices. Further details regarding computing devices are provided below in connection with FIG. 8, along with additional details about networks, such as the network 260 shown.

As mentioned, the mobile security unit 202 includes a computing device 204. The computing device 204 may include one or more processing and/or memory components for implementing a security monitoring system 206 and/or the intrusion detection system 210 and/or for storing surveillance data captured by the mobile security unit 202.

In various implementations, the security monitoring system 206 includes several elements, components, programs, and/or systems that facilitate security and surveillance by the mobile security unit 202. As shown, the security monitoring system 206 includes a thermal camera 230 (e.g., an IR camera, LWIR camera, or LWIR detection sensor), an alert system 232, sensors 234, and output devices 236. For example, the thermal camera 230 captures thermal video streams of the mobile security unit 202, and the alert system 232 activates one or more alert protocols, such as lights and speakers on the mobile security unit 202, or provides security alerts to a cloud security system 242 and/or a client device 250. The sensors 234 may include one or more proximity, movement (inertial movement unit (IMU)), climate, light, temperature, and other sensors to collect information used by the security monitoring system 206. The output devices 236 include one or more lights, speakers, displays, or projections that output messages, recordings, sounds, colors, intensities, patterns, and/or images from the mobile security unit 202.

In various implementations, the security monitoring system 206 performs several autonomous actions with the mobile security unit 202. In some cases, the security monitoring system 206 cooperates with a cloud security system 242 on the cloud computing system 240 to implement and/or report security actions.

As shown, the security monitoring system 206 implements the intrusion detection system 210. In many instances, the intrusion detection system 210 is integrated within the security monitoring system 206, including receiving input surveillance data and providing output calls to the security monitoring system 206. In some implementations, the intrusion detection system 210 is located on a separate computing device from the security monitoring system 206 within the mobile security unit 202.

In the illustrated example implementation, the intrusion detection system 210 includes various components and elements, which are implemented in hardware and/or software. For example, the intrusion detection system 210 includes a video stream manager 212, which receives thermal video streams 220 from the thermal camera 230 and facilitates video detection zones 222 within the thermal video streams 220. The intrusion detection system 210 also includes an object detection manager 214, which uses machine learning models (e.g., object detection neural networks) to identify persons within the video detection zones 222 and creates and updates tracking parameter sets for each detected person.

The intrusion detection system 210 also includes an alert conditions manager 216, which determines when a detected person poses a threat based on comparing tracking parameters 224 (tracking parameter sets) to alert condition sets 226 to determine if alert thresholds 228 (e.g., tampering and/or intrusion profiles) are met. For example, the alert conditions manager 216 determines a threat, severity, or escalation level based on which alert thresholds 228 are met. Further, the alert conditions manager 216 can directly or indirectly (via the alert system 232) cause the output devices 236 on the mobile security unit 202 to activate according to the corresponding escalation level.

The intrusion detection system 210 also includes a storage manager 218, which includes the thermal video streams 220, the video detection zones 222, the tracking parameters 224, the condition sets 226, and the alert thresholds 228, as mentioned above. In addition, the storage manager 218 can store other data used or accessed by the intrusion detection system 210.

As mentioned, the computing environment 200 includes a cloud computing system 240. In various implementations, the cloud computing system 240 provides cloud-based services for the mobile security unit 202 and/or the security monitoring system 206. For example, the cloud computing system 240 includes a cloud security system 242 that provides cloud-side services and processing supporting the security monitoring system 206. In various implementations, the cloud security system 242 provides remote processing for some or all of the functions of the intrusion detection system 210, such as intrusion detection.

As shown, the computing environment 200 includes the client device 250. In various implementations, the client device 250 is associated with a user (e.g., a user client device), such as a user who interacts with the security monitoring system 206. For instance, the client device 250 includes a client application 252, such as a web browser or another form of computer software application, which allows a user to interact with the security monitoring system 206. For example, in some instances, the user is a stakeholder and/or consumer who is provided with alerts and footage when one or more tampering and/or intrusion surveillance alerts are triggered at the mobile security unit 202. In some cases, the user can use the client application 252 to communicate with potential threats via the output devices 236 or disarm the intrusion detection system 210. As another example, the user is an administrator who defines the video detection zones 222, condition sets 226, and/or alert thresholds 228 of the intrusion detection system 210.

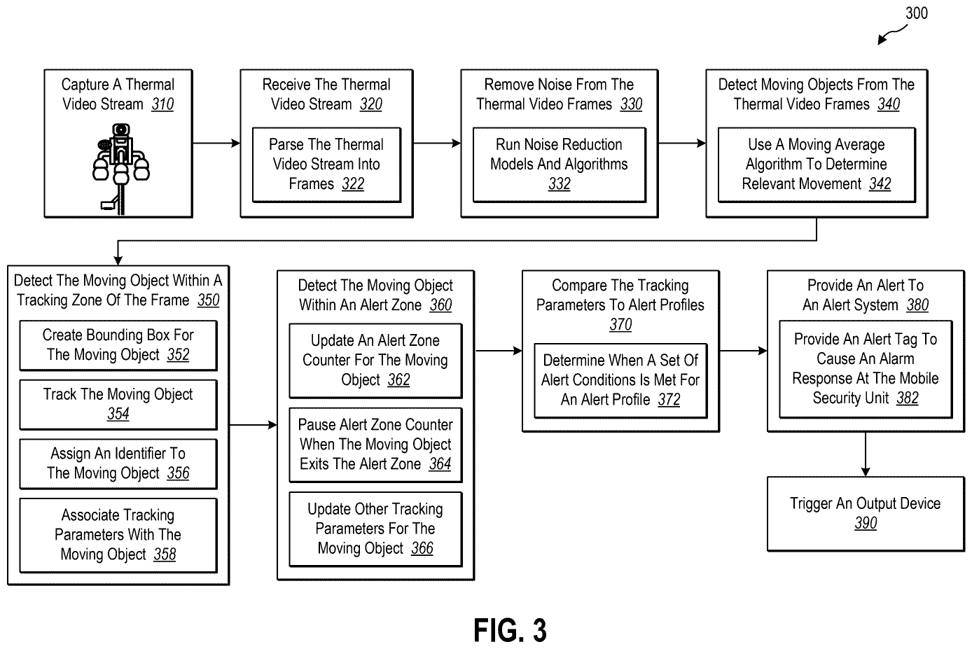

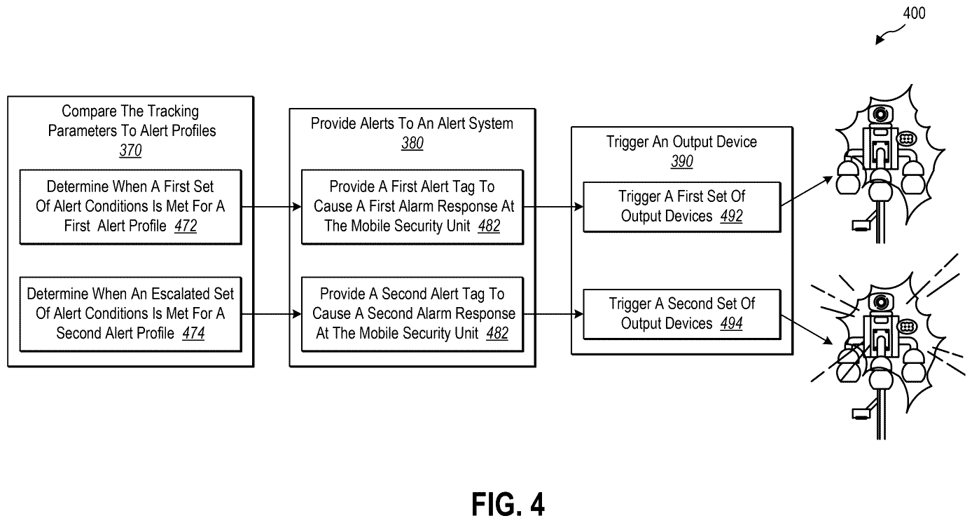

Turning now to FIG. 3 and FIG. 4, these figures each illustrate example flowcharts that include various series of acts for generating one or more output alerts at a mobile unit based on a detected intruder. To elaborate, FIG. 3 illustrates an example flow diagram for detecting and preventing tampering with a mobile unit according to some implementations.

As shown, FIG. 3 includes a series of acts 300 performed by or in connection with the intrusion detection system 210 for detecting persons intruding or tampering with an MSU. To begin, the series of acts 300 includes act 310 of capturing a thermal video stream. For example, one or more thermal cameras on the MSU, which are mounted on an upper section of the mast and/or near the top end, capture a top-down, downward-facing view of the MSU and the nearby surrounding areas in a thermal video stream. In many implementations, the thermal video stream is an infrared (IR) video stream captured with long-wave infrared (LWIR) sensors, which provides continuous detection independent of lighting or other environmental conditions. In various implementations, the thermal video stream is a low-resolution IR video stream (e.g., 160×120 pixels).

In one or more implementations, a controller (e.g., a computing device) on the MSU instructs a thermal camera to capture and return a continuous thermal video stream of the MSU. FIG. 3 includes act 320 of receiving the thermal video stream. For instance, the intrusion detection system 210 receives the thermal video stream from a single thermal camera or multiple thermal cameras. In some implementations, the intrusion detection system 210 receives the thermal video stream as a data stream via a serial bus communication protocol (e.g., USB).

As shown in FIG. 3, act 320 includes a sub-act 322 of parsing the thermal video stream into frames. In various implementations, upon receiving the thermal video stream, the intrusion detection system 210 parses the thermal video stream into a set of sequential thermal video frames. The set can include every video frame from the thermal video stream (e.g., 30 or 60 frames per second) or may omit one or more frames (e.g., omit every second, third, and/or fourth frame). In some implementations, the intrusion detection system 210 identifies a first sample of thermal video frames with a lower sampling rate (one or two frames per second) until a change is detected, and then identifies a second sample of the thermal video stream with a higher sampling rate (e.g., samples the thermal video stream more frequently, such as five or more frames per second).

Act 330 includes removing noise from the thermal video frames. In various implementations, the thermal video stream and the thermal video frames include noise such as blur, artifacts, and distortions. Noise becomes more evident when the thermal video frames are captured by a low-resolution thermal camera. In various instances, the noise can negatively affect the accuracy of detecting objects and object movement.

As shown, act 330 includes a sub-act 332 of running noise reduction models and algorithms. For example, in some implementations, the intrusion detection system 210 applies a Gaussian mixture model and/or another noise reduction model to reduce noise in the identified thermal video frames from the thermal video stream. In some instances, the intrusion detection system 210 removes artifacts from the thermal video frames of the thermal video stream using morphological mixing and/or another artifact smoothing model. In various implementations, the intrusion detection system 210 applies additional filtering techniques to remove noise from the thermal video frames, especially if the thermal video frames are of low resolution.

Act 340 includes detecting moving objects from the thermal video stream. In various implementations, the intrusion detection system 210 detects when the thermal video stream includes objects moving between frames. For example, the intrusion detection system 210 utilizes an object detection model (e.g., an object detection machine learning model or an object detection neural network) to identify moving objects based on changes between frames. In various implementations, the object detection model can classify the moving object as a person, animal, insect, vehicle, or another moving object.

Act 340 includes sub-act 342 of using a moving average algorithm to determine relevant movement. In various implementations, the intrusion detection system 210 utilizes a moving average or other movement algorithms to determine or identify moving objects based on average pixel intensity values. In particular, the intrusion detection system 210 uses movement algorithms to ensure that the movement of an object between two or more thermal video frames is relevant. For example, if the amount of movement of an object does not meet a movement threshold, the intrusion detection system 210 can dismiss the object as not significant or relevant. However, if the moving object moves significantly between thermal video frames, then the movement threshold will be met, and the intrusion detection system 210 can determine to begin tracking the object.

In various implementations, the intrusion detection system 210 applies the moving average algorithm or model for newly detected moving objects. In some implementations, the intrusion detection system 210 uses alternative object detection techniques or models to determine whether a detected moving object is relevant or significant. In one or more implementations, the intrusion detection system 210 tracks all moving objects that meet at least a minimal object detection size.

Act 350 includes detecting the moving object within a tracking zone of the frame. In some implementations, the intrusion detection system 210 detects moving objects that are within one or more monitoring zones of the thermal video frames. As mentioned above, a monitoring zone can include a tracking zone, which corresponds to a virtual boundary within the thermal video stream where moving objects are detected. In some instances, a tracking zone aligns with the full frame size of a thermal video frame. In other instances, the tracking zone is smaller than the full frame size, and the intrusion detection system 210 ignores movement outside of the tracking zone. In these instances, the intrusion detection system 210 can ensure that only essential areas surrounding the MSU are monitored, thereby reducing the computational resources needed to detect and track moving objects (e.g., persons) that intrude upon the MSU.

As shown, act 350 includes a first sub-act 352 of creating bounding boxes for the moving object. For example, for detected moving objects within a tracking zone determined to be relevant (e.g., detected persons), the intrusion detection system 210 can begin to track movement in future frames. As part of the movement tracking, the intrusion detection system 210 generates a bounding box around the moving object (e.g., persons) that follows the moving object from frame to frame. Accordingly, act 350 can include a second sub-act 354 of tracking the moving object.

Act 350 can also include a third sub-act 356 of assigning an identifier to the moving object. For instance, because multiple objects can be detected within a thermal video frame, the intrusion detection system 210 can assign the detected moving object a unique identifier. The intrusion detection system 210 can assign different identifiers to the detected moving objects within the tracking zone.

Furthermore, act 350 includes a fourth sub-act 358 of associating tracking parameters with the moving object. In addition to assigning an identifier, the intrusion detection system 210 also generates and/or associates one or more tracking parameters with the moving object, which are used to determine whether the moving object poses an intrusion or tampering thread to the MSU. For example, the intrusion detection system 210 associates tracking parameters corresponding to the detected movement direction and velocity captured by the thermal video frames. As another example, the intrusion detection system 210 creates and associates one or more counters with the moving object that corresponds to the time spent within a monitoring zone. The intrusion detection system 210 may create, detect, monitor, track, identify, associate, and/or update one or more tracking parameters for the detected moving object, as captured by the thermal video frames.

In some implementations, the intrusion detection system 210 associates tracking parameters captured from additional sensors of the MSU. For example, the intrusion detection system 210 uses proximity sensors on the MSU to detect movement, speed, pace, and proximity of the detected moving object, which the intrusion detection system 210 can associate with the moving object as one or more tracking parameters. In some implementations, the intrusion detection system 210 associates unit movement (e.g., using an IMU) as a tracking parameter related to a detected person to indicate if the person has physically contacted the MSU. The intrusion detection system 210 may include tracking parameters based on other sensor data (e.g., one or more cameras, weather sensors, microphones, motion sensors, noise sensors, temperature sensors, chemical sensors, and any other suitable sensors).

Act 360 includes detecting the moving object within an alert zone. As mentioned above, the intrusion detection system 210 can utilize multiple monitoring zones, such as the tracking zone and the alert zone. In many instances, the alert zone is located within some or all of the tracking zones. For example, the alert zone covers the MSU and the immediate surrounding areas, while the tracking zone covers a wider area within the thermal video frames.

In various implementations, the intrusion detection system 210 determines when the detected moving object moves within the alert zone. For instance, the intrusion detection system 210 monitors the detected moving object within the tracking zone and identifies when the object enters the alert zone, indicating that the moving object is approaching the MSU.

As shown, act 360 includes a first sub-act 362 of updating an alert zone counter for the moving object. For instance, upon detected the moving object initially moving within the alert zone, the intrusion detection system 210 begins an alert zone counter that tracks the time of the moving object within the alert zone. In various instances, the intrusion detection system 210 may pause or restart the alert zone counter if the moving object moves outside of the alert zone. For example, when the detected moving object crosses out of the alert zone into the tracking zone, the intrusion detection system 210 pauses the alert zone counter, as shown in the second sub-act 364, while maintaining the identifier and tracking parameters for the object. The intrusion detection system 210 then resumes the alert zone counter if the moving object moves back into the alert zone. In these instances, the intrusion detection system 210 maintains a cumulative time that the moving object remains in the alert zone. In some instances, the intrusion detection system 210 additionally, or in the alternative, includes a tracking parameter corresponding to only the most recent duration that the moving object remains in the alert zone.

Act 360 also includes a third sub-act 366 of updating other tracking parameters for the moving object. For instance, the intrusion detection system 210 continues to monitor and update the tracking parameters for the moving object. As described below, the intrusion detection system 210 uses one or more tracking parameters to determine whether the moving object poses a threat and to what extent (e.g., severity level) the threat arises.

Act 370 includes comparing the tracking parameters for the moving object to alert profiles. In various implementations, the intrusion detection system 210 maintains a set of alert profiles. For example, the intrusion detection system 210 maintains different alert profiles corresponding to different severity levels of intrusion or tampering with the MSU. For instance, the alert profiles include low, medium, high, and urgent severity alert profiles.

Each alert profile can include an alert threshold based on a set of alert conditions being met for a set of tracking parameters. For example, a first alert profile can include a first set of alert conditions for a set of tracking parameters that, when met, triggers a first alert threshold. Similarly, a second alert profile can include a second set of alert conditions for the tracking parameters (e.g., the same or different tracking parameters) that, when met, triggers a second alert threshold.

In various implementations, the tracking parameter corresponds to the tracking parameters maintained for a detected moving object (e.g., a detected person). Accordingly, as shown in act 370, the intrusion detection system 210 can compare the tracking parameters for the moving object to the alert profiles to determine whether one or more sets of alert conditions and alert thresholds are met.

As shown, act 370 includes a sub-act 372 of determining when a set of alert conditions is met for an alert profile. For example, the intrusion detection system 210 compares the set of tracking parameters for the moving object (e.g., a detected person) detected within the alert zone to the sets of alert conditions from various alert profiles. To illustrate with a simple example, the intrusion detection system 210 includes three alert profiles that each contain different parameter condition amounts for the alert zone counter parameter. For example, a first alert profile indicates that a first alert zone timer threshold is met when the alert zone counter is between 3 and 5 seconds. A second alert profile indicates that a second alert zone timer threshold is met when the alert zone counter is between 5 and 10 seconds, and a third alert profile indicates that a third alert zone timer threshold is met when the alert zone counter is above 10 seconds.

In the above example, when the moving object has an alert zone counter that exceeds 3 seconds, the intrusion detection system 210 determines that the first alert threshold for the first profile is met. When the moving object has an alert zone counter that exceeds 5 seconds, the intrusion detection system 210 determines that the first alert zone timer threshold for the first profile is no longer satisfied, but that the second alert threshold for the second profile is met.

Expanding on the simple example above, each alert profile can have an alert threshold that corresponds to multiple alert conditions being met for different tracking parameters. In some implementations, an alert threshold requires that a minimum amount (e.g., number or percentage) of conditions be met (e.g., 7 out of 10 conditions in an alert profile must be satisfied to meet its alert threshold). In one or more implementations, the conditions are weighted, making some conditions more impactful. In many instances, meeting the alert threshold for an alert profile will be the result of multiple alert conditions or combinations of alert conditions being satisfied. In various implementations, the intrusion detection system 210 utilizes a machine learning model that compares the tracking parameters for the moving object to sets of alert conditions for each alert profile to determine if an alert threshold for that alert profile is met.

In various implementations, the alert conditions can specify target values for tracking parameters for a detected moving object obtained from surveillance data captured from the thermal video stream. The alert conditions can also include target values for other tracking parameters for the detected moving object from surveillance data obtained from other sensors on the MSU.

As mentioned above, the alert conditions can specify target tracking parameter values for surveillance data captured from the thermal video stream of a detected moving object. The alert conditions can also specify target tracking parameter values for surveillance data captured from onboard sensors, cameras, microphones, and detectors. For example, an alert condition can include whether the detected moving object is moving toward the MSU, moving away from the MSU (e.g., walking by), whether the moving object is approaching at a certain speed, or whether the moving object is idling near the MSU (e.g., within the alert zone) below a certain speed. This alert condition can be met based on tracking parameters from either the thermal video stream or proximity sensors.

The intrusion detection system 210 can change the set of conditions required for an alert threshold to be met for an alert profile to be activated. In various implementations, the set of alert conditions for an alert profile can vary based on one or more factors. For example, the intrusion detection system 210 can change the set of alert conditions based on the traffic type, environment type, weather, date/time, available power resources, or other factors.

To illustrate, an MSU may be placed in a sterile or non-sterile environment. In many instances, a sterile environment is one where detected persons are not expected. For instance, a sterile environment may be located within a secured area (e.g., within a fenced-off area, indoors, or at a physically remote location). Pedestrian traffic is not expected in a sterile environment. A non-sterile environment may be one where non-threatening persons are expected to be detected on an occasional or regular basis, such as a parking lot.

The intrusion detection system 210 may apply different alert condition sets for the same profile based on whether the MSU is deployed in a sterile environment or a non-sterile environment. For example, a first alert profile for an MSU in a sterile environment may have a set of alert conditions that activate the first alert profile upon detecting a person, while the first alert profile for an MSU in a non-sterile environment may have a different set of alert conditions that activate the first alert profile when multiple conditions are met. In some instances, the alert zone timer threshold for the MSU in the sterile environment may be shorter than in the non-sterile environment.

In various implementations, the set of alert conditions for an alert profile is based on date and time information (e.g., time of day, the day of the week, and holidays). For example, for an MSU placed in a parking lot that is busy during the day, the intrusion detection system 210 applies a set of non-sterile alert conditions as pedestrian traffic is expected. During nights, weekends, or other times when the parking lot is expected to be empty and/or closed, the intrusion detection system 210 applies a set of sterile alert conditions as pedestrian traffic is not expected. The intrusion detection system 210 may apply various sets of alert conditions for an alert profile based on different times throughout the day or week.

In some implementations, the intrusion detection system 210 changes the set of alert conditions based on weather. For example, during inclement weather, such as heavy precipitation, where the weather may trigger false positive alerts, the intrusion detection system 210 relaxes the set of alert conditions. Similarly, when the power resources of an MSU are low, the intrusion detection system 210 may relax alert conditions to reduce computational processing requirements.

In some instances, an alert profile has multiple ways that the alert threshold can be satisfied. For example, the alert threshold for a high-severity alert profile can be triggered if any one of the following conditions met: the alert zone counter exceeds 15 seconds; the alert zone counter exceeds 10 seconds, and the moving object is within 2 feet of the MSU; if the IMU detects the MSU being moved with at least a specified amount of force (e.g., the detected person has contacted the MSU); or if the moving object enters a specialty alert zone (e.g., the battery compartment) for more than 2 seconds.

As indicated in the description above, the intrusion detection system 210 can maintain any number of alert profiles that include any combination of alert condition sets to satisfy alert thresholds. By doing so, moving objects that follow known malicious action patterns can be detected. Alert profiles can also correspond to any type or level of alert severity for detecting intrusion and tampering with an MSU. In addition, alert profiles can be added, edited, removed, or otherwise modified to determine how and when corresponding alert thresholds are met.

Act 380 includes providing an alert to an alert system. For example, upon a moving object meeting or matching an alert profile (based on alert conditions that satisfy the alert threshold), the intrusion detection system 210 provides a corresponding severity alert to an alert system. Specifically, the intrusion detection system 210 provides alert indicators to a security monitoring system, which triggers one or more alarm responses at the MSU.

In various implementations, an alarm response includes triggering one or more output devices, such as lights, sounds, digital displays, or movements. The alarm system may activate the type of alarm response according to the alert indication received from the intrusion detection system 210. For example, a particular alarm indication may cause the MSU to function as a car alarm, with lights flashing in various colors and patterns and speakers emitting loud sounds, noises, and/or verbal messages (e.g., live and/or recorded). Some alarm indications may only trigger additional monitoring and/or notifications without activating or modifying the output devices of the MSU.

Additionally, providing specific types of alarm alerts to the alarm system may cause the alarm system to perform additional actions. For example, in response, the alarm system begins logging the intrusion event and/or recording data from additional sensors or cameras and sends messages (e.g., text and/or email) to a front-end device (e.g., a client device 250) associated with a user and/or an administrator or places a call to a user or administrator.

As shown, act 380 includes sub-act 382 of providing an alert tag to cause an alarm response at the mobile security unit (MSU). In some instances, the provided alert is an alert tag or label (e.g., non-threatening, pre-alert, alert, potential tampering, active tampering, high alert, high severity). The alert tag indicates to the alert system the threat severity of the detected moving object (e.g., bad actor) and/or how to respond to the provided alert.

In some instances, an alert tag causes the alert system to notify users, administrators, and/or other parties regarding the tampering threat to the MSU. In various implementations, an alert tag directs the alert system to focus a light or high-definition camera on the bad actor. In some implementations, an alert tag causes the alert system to direct other devices and/or output devices to focus attention on the MSU and the bad actor (e.g., turn on surrounding lights, record the bad actor from nearby MSUs or security cameras, secure physical security boundaries).

In some instances, the intrusion detection system 210 does not utilize an alert system. For example, the intrusion detection system 210 directly triggers output devices on the MSU and/or nearby devices. For instance, upon identifying a potential tampering alert, the intrusion detection system 210 causes lights, sounds, digital displays, or movements to occur on the MSU to capture and/or ward off the bad actor or suspect. In addition, the intrusion detection system 210 may contact users, allowing them to remotely interact with the output devices of the MSU to communicate with the bad actor. The intrusion detection system 210 may also contact security or law enforcement to arrive at the location of the MSU.

Act 390 includes triggering an output device. In various instances, based on the provided alert or alert tag, the intrusion detection system 210, the alert system, and/or the security monitoring system activate or modify one or more output devices on the MSU, as described above (e.g., turning a spotlight, flashing a colored light, and/or playing a siren, a beep, or a verbal message) in the direction of the suspect or bad actor.

FIG. 4 illustrates an example flow diagram for detecting escalating tampering threats to a mobile unit and causing the mobile unit to provide escalating alerts according to some implementations. As shown, FIG. 4 includes a series of acts 400 performed by or in connection with the intrusion detection system 210 at an MSU. In particular, act 400 expands on acts 370, 380, and 390 from the series of acts 300, described above, to show how the intrusion detection system 210 can escalate intrusion detection and tampering alerts at the MSU.

As shown, the series of acts 400 includes act 370 of comparing the tracking parameters to alert profiles, which is described above. Act 370 includes a first sub-act 472 of determining when a first set of alert conditions is met for a first alert threshold. For example, when the intrusion detection system 210 compares the tracking parameters for a first detected moving object to a first set of alert conditions and determines that the alert conditions are met. For instance, the moving object is within close proximity of the MSU (e.g., 1 foot) and has little or no movement speed (e.g., under 1 mile per hour).

In response, the intrusion detection system 210 performs sub-act 482 of providing a first alert tag to cause a first alarm response at the MSU, which is part of act 380. For example, the intrusion detection system 210 sends a potential intruder alert tag to the alarm system in response to determining that the actions of the detected moving object meet the first alert profile.

Additionally, providing the first alert tag may cause the intrusion detection system 210 to trigger a first set of output devices, as shown in the first sub-act 492 of act 390, as shown. For example, in response to the first alert, the MSU activates additional lights to illuminate the unit and/or provide loud siren chirps to notify the bad actor regarding their detection.

As the moving object continues to remain in the alert zone (e.g., near the MSU), the intrusion detection system 210 can continue to update the tracking parameters. Accordingly, the intrusion detection system 210 continues to compare the tracking parameters of the moving object (e.g., the detected person) to the various alert profiles. As mentioned above, the alert profiles may correspond to escalating severity levels.

To illustrate, sub-act 474 of act 370 includes determining when an escalating set of alert conditions is met for a second alert threshold. For example, the intrusion detection system 210 determines that the tracking parameters for the first detected moving object meet the second, escalated set of alert conditions. For instance, an IMU signals that the moving object is physically contacting the MSU. As a result, the intrusion detection system 210 determines that the escalated alert conditions are met.

In some instances, the intrusion detection system 210 meets one alert threshold at a time. For instance, when the escalating alert profile is triggered or activated, the first alert profile is untriggered. In various implementations, multiple alert profiles can be triggered together as long as the alert condition set for each alert profile is satisfied.

In response to the second alert profile being met, the intrusion detection system 210 provides a second alert tag to initiate a second alarm response at the MSU, as shown in sub-act 484, which is also part of act 380. For example, the intrusion detection system 210 sends an active intruder alert tag to the alarm system after determining that the actions of the detected moving object meet the second, escalated alert profile.

Additionally, providing the second alert tag may cause the intrusion detection system 210 to trigger a second set of output devices, as shown in the second sub-act 494 of act 390, as shown. For example, in response to the second alert, the MSU rotates and shines spotlights on the detected suspect and provides loud continuous sirens to notify the intruder or suspect regarding their detection. The MSU may also notify a user, administrator, security personnel, and/or law enforcement of the detected intruder tampering with the MSU. Indeed, as more severe tracking parameters are detected, the intrusion detection system 210 may determine increases in threat severity and trigger escalating responses.

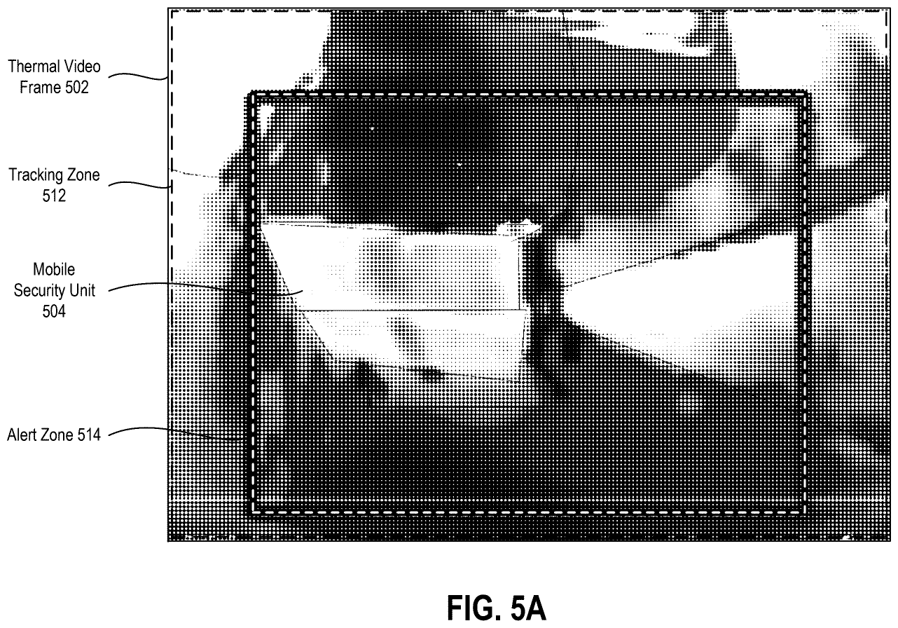

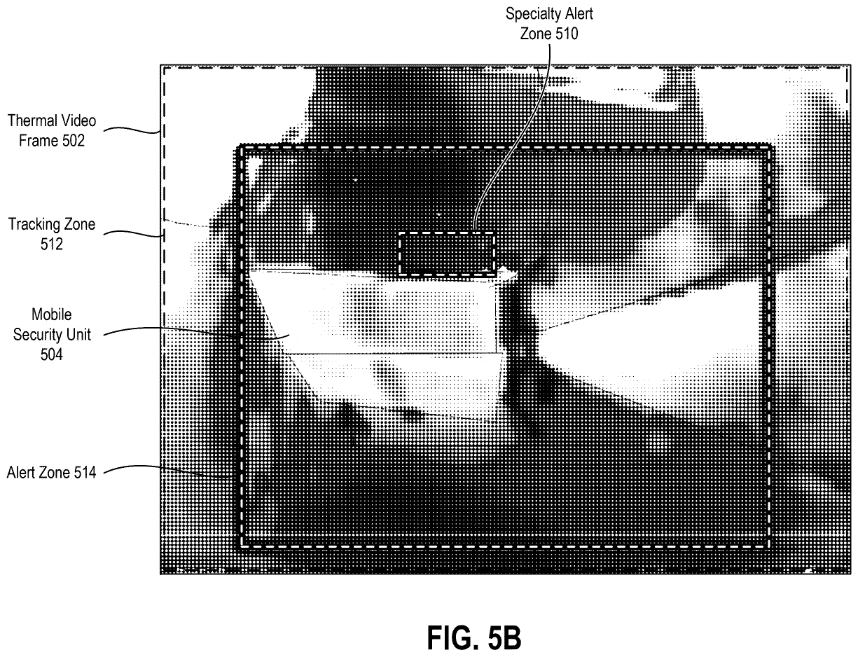

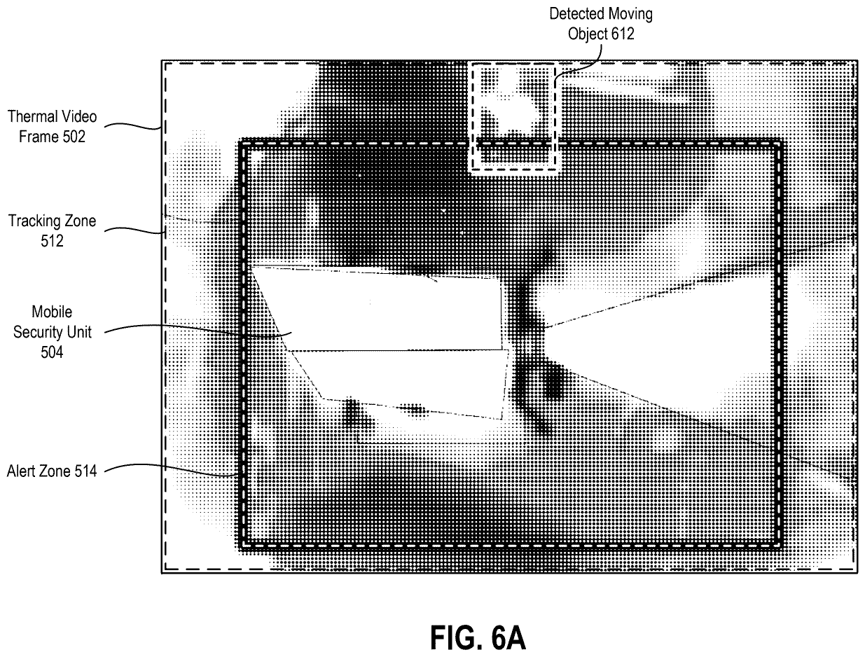

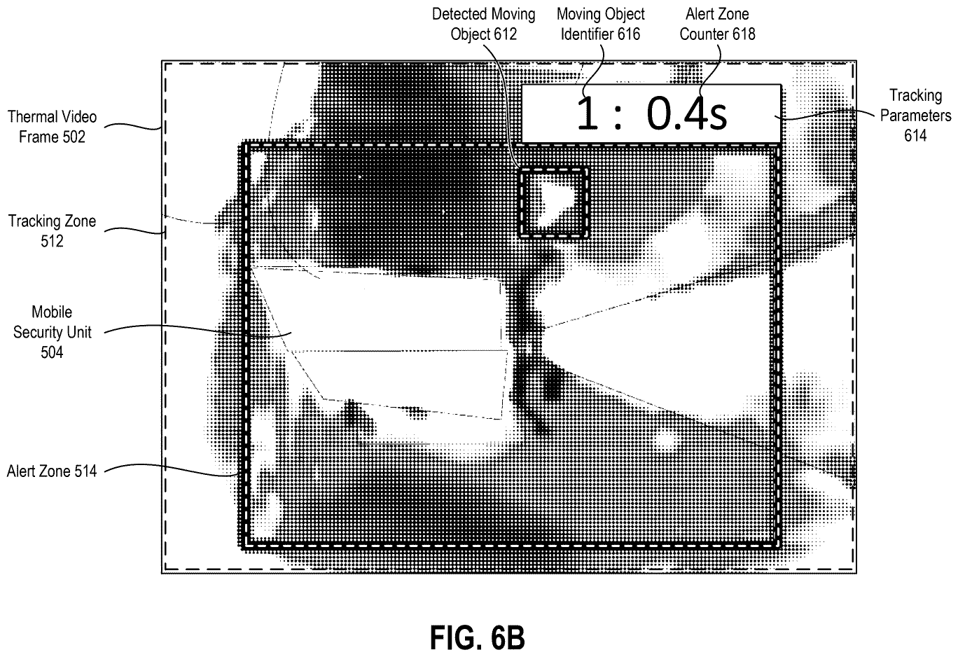

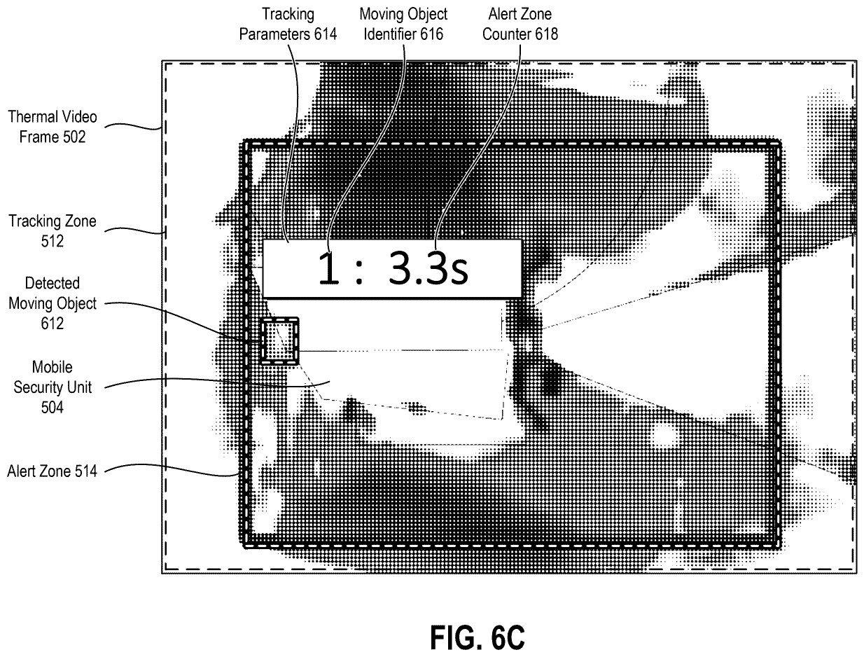

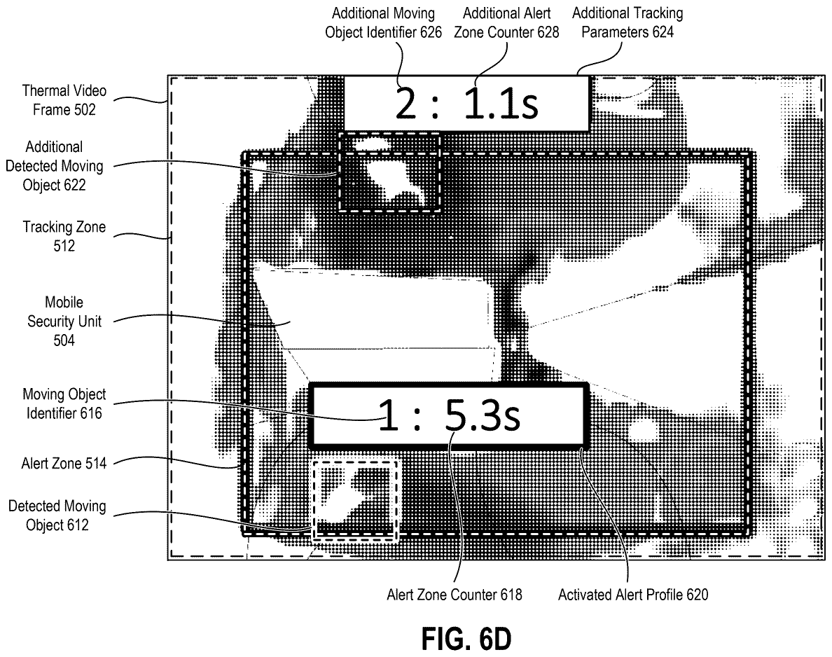

Turning to the next set of figures, FIGS. 5A-5B and FIGS. 6A-6D provide example thermal video frames that display one or more detected moving objects. These figures represent a sequence of thermal video image frames captured by a thermal camera. The image frames depict a downward-looking, top-down view of a mobile unit (e.g., MSU). For example, the image frames are captured by a thermal camera mounted near the top end of the mast, above the MSU.

The image frames include an MSU, shown in the center, and areas surrounding the MSU. The image frames also show solar panels of the MSU in the center-left of the frames. To the center-right of the image frames, a mast or pole of the MSU is depicted. In some instances, the mast and/or the solar panels may create blind spots for the intrusion detection system 210 when tracking detected persons, as described below.

Additional details regarding the thermal video frames are provided with the description of FIGS. 5A-5B and FIGS. 6A-6D. To illustrate, FIGS. 5A-5B show a user interface that includes an example thermal video frame from a thermal video stream that includes monitoring zones according to some implementations. For example, FIG. 5A includes a thermal video frame 502 (e.g., a thermal image frame) obtained from a thermal video stream. The thermal video frame 502 includes a mobile security unit 504 (MSU), as mentioned above.

In various implementations, the thermal video frame 502 has a field of view (FOV) (e.g., coverage area) around the mobile security unit 504 that is approximately 40 feet by 25 feet, with the MSU in the center. If the MSU, the mast, or the thermal camera mounting area is not level, the MSU may not be centered, or the dimensions of the FOV may be skewed. Furthermore, raising or lowering the thermal camera relative to the base components of the MSU or the ground can increase and/or decrease the FOV. Similarly, changing the lens type of a thermal camera could result in a wider or narrower FOV.

As shown, the thermal video frame 502 includes monitoring zones having a tracking zone 512 and an alert zone 514. Monitoring zones can be any shape or combination of shapes within the thermal video frame 502. In some implementations, the intrusion detection system 210 enables a user or administrator to configure the shapes or outlines of monitoring zones. In some implementations, a machine learning model defines one or more of the monitoring zones. For example, the intrusion detection system 210 trains, generates, obtains, or fine-tunes a zone-determination neural network to determine a tracking zone and/or an alert zone based on environmental objects and factors of a thermal video frame.

As provided above, the intrusion detection system 210 utilizes the tracking zone 512 to identify and monitor the movement of potential intrusion and tampering threats against the mobile security unit 504. In some instances, the tracking zone 512 matches the size of the thermal video frame 502. For example, the tracking zone 512 fully overlaps the pixels of the thermal video frame 502.

In some implementations, the tracking zone 512 is smaller than the thermal video frame 502 on one or more sides. For instance, if the deployed location of an MSU is a parking stall in a busy parking lot, the tracking zone 512 may be defined to not include an adjacent parking stall or a sidewalk within the FOV. By doing so, the intrusion detection system 210 reduces the number of false positive alerts by omitting areas with non-threatening pedestrian traffic. Furthermore, by limiting the monitored area to areas just around an MSU, the intrusion detection system 210 reduces the amount of computing resources needed to detect, track, and monitor detected persons (e.g., potential suspects).

As shown, these figures include a thermal video frame 502 that shows thermal images of a mobile security unit 504. These figures also include a thermal video frame 502, a tracking zone 512, and an alert zone 514, which are described above. The intrusion detection system 210 can include any number, type, shape, and/or size of monitoring zones within the thermal video frame 502.

As mentioned above, the thermal video frame 502 shows an alert zone 514 within the tracking zone 512. While the tracking zone 512 captures areas near the mobile security unit 504, the alert zone 514 captures the mobile security unit 504 itself and the immediately surrounding areas. In various implementations, the alert zone 514 may be defined to cover the areas within a predetermined number of feet surrounding the mobile security unit 504 (e.g., 2 feet, 3 feet, 5 feet).

In one or more implementations, the alert zone 514 overlays the tracking zone 512. For example, the alert zone 514 further defines the tracking zone 512 by indicating portions of the tracking zone 512 that are subject to heightened monitoring. In some implementations, the tracking zone 512 and the alert zone 514 are separate zones.

FIG. 5B shows the thermal video frame 502 of FIG. 5A and adds a specialty alert zone 510. For example, the specialty alert zone 510 is added to provide an additional layer of security to protect the mobile security unit 504 against tampering and intrusion. For instance, a specialty alert zone 510 is over the battery compartment of the MSU. In various implementations, a specialty alert zone corresponds with a heightened security or surveillance level. The intrusion detection system 210 can temporarily, conditionally, or permanently add any number of specialty alert zones to the thermal video frame 502.

FIGS. 6A-6D expand on the concepts introduced in FIGS. 5A-5B with regard to detecting persons within the thermal video frame 502. In particular, FIGS. 6A-6D illustrate thermal video frames from a thermal video stream of a detected person within an alert zone associated with the mobile unit according to some implementations.

To illustrate, FIG. 6A shows the intrusion detection system 210 detecting a person within the tracking zone 512, as indicated by the detected moving object 612. As mentioned above, the intrusion detection system 210 compares pixel movement between one or more previous thermal video frames and the thermal video frame 502 to determine movement within the thermal video frame 502. The intrusion detection system 210 may use a moving average algorithm to determine whether the movement is significant and/or relevant. In some instances, the intrusion detection system 210 uses an object detection neural network to determine that the moving object is a person, vehicle, or other meaningful object to be tracked (rather than an insect, small animal, rodent, or noise).

Upon identifying a detected moving object 612 within the tracking zone 512, the intrusion detection system 210 surrounds the detected person (or other relevant object) with a bounding box. The intrusion detection system 210 continues to move the bounding box around the detected person as they move within the tracking zone 512. If multiple persons are detected within the tracking zone 512, the intrusion detection system 210 can create a bounding box for each one.

FIG. 6B shows the detected person moving into the alert zone 514. As described above, upon a detected person being identified within the alert zone 514, the intrusion detection system 210 performs a set of actions to associate surveillance data with the detected person. For example, the intrusion detection system 210 assigns tracking parameters 614 to the detected person. As shown, the tracking parameters 614 include a moving object identifier 616 and an alert zone counter 618 assigned to the detected person. The intrusion detection system 210 can assign and/or associate additional tracking parameters to the detected person, which the intrusion detection system 210 can selectively display within the thermal video frame 502.

As shown, the moving object identifier 616 maintains a record of which detected moving object is associated with a set of tracking parameters. This becomes more important as multiple detected moving objects are identified, either at the same time or within a detection time period.

The alert zone counter 618 associated with a moving object identifier 616 can indicate the amount of time that the detected moving object 612 remains in the alert zone 514. In many instances, the alert zone counter 618 is a cumulative amount of time that counts up or increments while the detected moving object 612 remains within the alert zone 514. In some implementations, the alert zone counter 618 restarts each time the detected moving object 612 re-enters the alert zone 514. In various implementations, the intrusion detection system 210 maintains a separate alert zone counter (e.g., a current alert zone counter) that tracks time in the alert zone 514 since the last re-entry.

As mentioned, in many implementations, the alert zone counter 618 maintains a total time spent in the alert zone 514 for the detected person. In various implementations, the alert zone counter 618 pauses while the detected person is outside of the alert zone 514. For example, upon the detected person first entering the alert zone 514, the intrusion detection system 210 initializes and starts the alert zone counter 618. As the detected person moves around within the alert zone 514, the intrusion detection system 210 increments the alert zone counter 618. When the person exits the alert zone 514 and enters the tracking zone 512, the intrusion detection system 210 pauses or halts the alert zone counter 618. Upon re-entry to the alert zone 514, the intrusion detection system 210 again resumes the alert zone counter 618.

As with the alert zone counter 618, the intrusion detection system 210 can continue to track and/or display the tracking parameters 614 for a detected person even when they move back into the tracking zone 512. Indeed, in various implementations, once tracking parameters are assigned to a detected person, the intrusion detection system 210 can maintain the tracking parameters until they exit the thermal video frame 502.

As shown in FIG. 6C, the detected moving object 612 is partially blocked by the solar panels of the mobile security unit 504. In various implementations, the detected person can become hidden or occluded by objects within the thermal video frame 502. The intrusion detection system 210 can continue to track the detected person even when they are occluded. For example, the intrusion detection system 210 uses one or more tracking parameters (e.g., velocity, speed, and/or direction) of the detected moving object 612 to determine the position or location of the detected person while they are occluded (e.g., represented by a bounding box of where the person is expected to be as if the obstruction were not present). If the detected person remains hidden for longer than a predetermined amount of time, the intrusion detection system 210 may stop tracking the person.

In various implementations, an occlusion or obstruction is caused by a camera blind spot in a thermal video frame. For example, as shown, the mast causes a blind spot on the right side of the thermal video frame 502. When a detected person passes behind the blind spot caused by the mast, the intrusion detection system 210 uses prediction techniques to estimate their location. The intrusion detection system 210 can also continue to update the tracking parameters 614, such as incrementing the alert zone counter 618.

In various implementations, the intrusion detection system 210 modifies the appearance of the tracking parameters 614 to indicate that the detected person is hidden. For example, the intrusion detection system 210 changes the appearance of the tracking parameters 614 displayed in the thermal video frame 502. For instance, the intrusion detection system 210 changes the color, size, or font of the tracking parameters 614 or modifies the appearance to add emphasis.

As also shown in FIG. 6C, the intrusion detection system 210 continues to track the detected moving object 612 and updates the tracking parameters 614 while the detected person remains within the alert zone 514. For example, as shown by the alert zone counter 618, the detected person has wandered around the mobile security unit 504 for an additional three seconds. Along with updating the tracking parameters 614 of the detected moving object 612, the intrusion detection system 210 compares the tracking parameters 614 against the various alert profiles to determine when an alert profile becomes activated.

To illustrate, FIG. 6D shows an activated alert profile 620 for the detected moving object 612. For instance, based on the tracking parameters 614 meeting a set of conditions of an alert threshold for an alert profile, the intrusion detection system 210 activates the alert profile. For example, given an alert condition of remaining in the alert zone 514 for over 5 seconds, the alert zone counter 618 meets the corresponding alert zone timer threshold, activating the alert profile. In various implementations, activating the alert profile includes providing an alert profile tag or indicator to an alarm system to trigger an appropriate response.

In various implementations, the intrusion detection system 210 modifies the appearance of the tracking parameters 614 in the thermal video frame 502 to indicate that an alert profile has been activated. For example, the intrusion detection system 210 changes the look or appearance of the tracking parameters 614 to signal an active alert profile. As shown, the intrusion detection system 210 increases the line weight around the tracking parameters 614. In some instances, the intrusion detection system 210 can add a tag or label near the detected moving object 612. For instance, the intrusion detection system 210 adds a label of “Detected Intruder” next to the detected moving object 612 and/or the tracking parameters 614 within the thermal video frame 502.

The intrusion detection system 210 can continue to monitor the detected moving object 612, update the tracking parameters 614, and compare the updated tracking parameters to alert profiles. By doing so, the intrusion detection system 210 can continue to escalate the deterrence response if the detected person (e.g., the suspect) continues to intrude. For instance, if an alert profile associated with a higher severity level is determined and activated, the intrusion detection system 210 provides notification of the escalated alert profile. In some implementations, the intrusion detection system 210 can have multiple alert profiles activated. In some implementations, the intrusion detection system 210 deactivates a current alert profile before activating a new alert profile.

As mentioned above, the intrusion detection system 210 can track multiple detected persons. To illustrate, FIG. 6D includes a second detected person with the alert zone 514. In particular, based on the additional detected person entering within the alert zone 514, the intrusion detection system 210 creates an additional detected moving object 622 having additional tracking parameters 624, which include an additional moving object identifier 626 and an additional alert zone counter 628.

The intrusion detection system 210 can independently track each detected person, compare their surveillance to the alert profiles, and respond when an alert profile is activated, as provided above. In some implementations, a set of alert conditions includes conditions that are based on detecting multiple persons in the alert zone 514. For instance, an alert condition is met when the total time (e.g., the alert zone counter) of all detected persons exceeds the alert zone time threshold.

As mentioned above, the intrusion detection system 210 may perform the operations and actions described above locally at a mobile unit. Further, by using limited FOVs (e.g., coverage areas) around an MSU and/or low-resolution thermal images, the intrusion detection system 210 can significantly reduce the processing power needed to detect intruders that would tamper with the MSU. Indeed, when an intruder is detected, the intrusion detection system 210 can continue to provide an escalated response at the MSU until tampering halts.

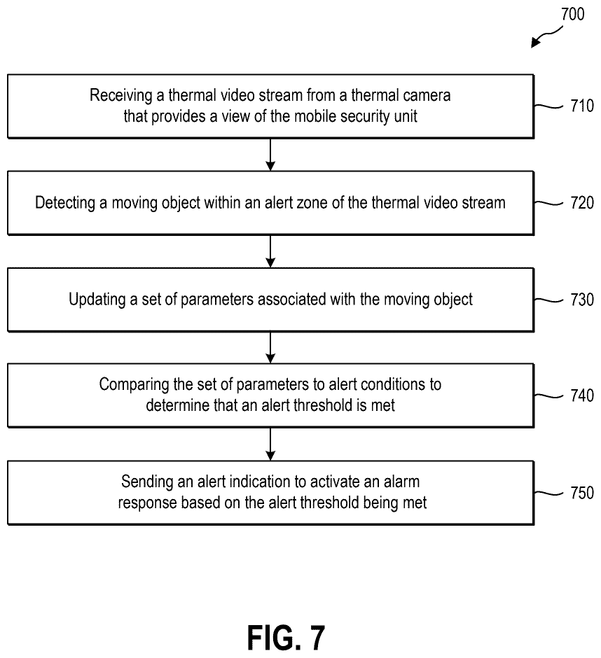

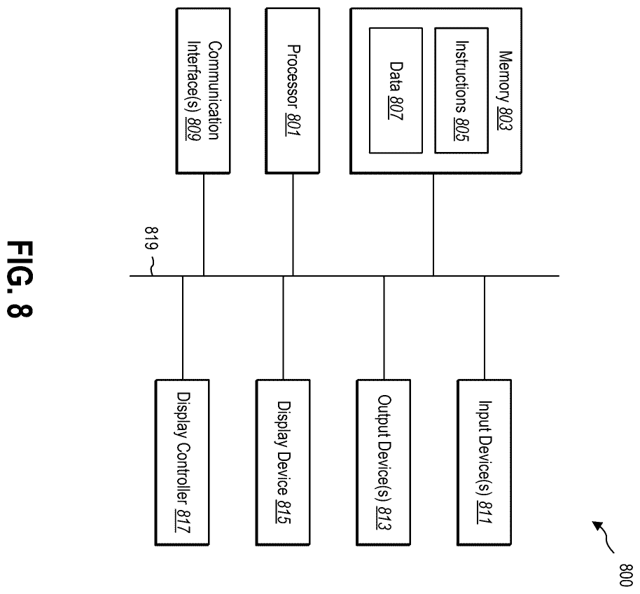

Turning now to FIG. 7, these figures each illustrate an example flowchart that includes a series of acts for using the intrusion detection system. In particular, FIG. 7 illustrates an example series of acts in a computer-implemented method for determining threats to a mobile security trailer according to some implementations.

While FIG. 7 illustrates acts according to one or more implementations, alternative implementations may omit, add to, reorder, and/or modify any of the acts shown. Furthermore, the acts of FIG. 7 can each be performed as part of a method (e.g., a computer-implemented method). Alternatively, a computer-readable medium can include instructions that, when executed by a processing system having a processor, cause a computing device to perform each of the acts of FIG. 7. In some implementations, a surveillance system, which includes a processing system with a processor and computer memory, can perform each of the acts of FIG. 7. For example, the memory includes instructions that, when executed by the processing system, cause the system to perform various acts in the series.

In one or more implementations, the acts of FIG. 7 can each be performed by an intrusion detection system and/or a mobile security unit (e.g., an MSU). In some instances, the MSU includes a mast having a top end and a lower end. In addition, the MSU includes a thermal camera coupled or attached to the top end of the mast, where the thermal camera is configured to provide a thermal video stream with a top-down view of the mobile security unit. In some implementations, the MSU can include an onboard computer having a processor and computer memory with instructions that, when executed by the processor, cause the MSU to carry out the series of acts.

As shown in FIG. 7, the series of acts 700 includes act 710 of receiving a thermal video stream from a thermal camera that provides a view of the mobile security unit. For instance, in various implementations, act 710 involves receiving a thermal video stream from a thermal camera coupled near the top end of a mast of a mobile security unit, where the thermal video stream provides a top-down view of the mobile security unit. In various implementations, the thermal video stream includes a tracking zone corresponding to the tracking movements of objects moving within the tracking zone. In some instances, the thermal video stream includes the tracking zone surrounding the alert zone and the alert zone surrounding the mobile security unit, where the alert zone corresponds to the tracking movements of objects near the mobile security unit.

In some implementations, the thermal camera is an infrared thermal imaging camera. In various implementations, the thermal video stream includes a low-resolution video stream, noise is reduced from the low-resolution video stream using a Gaussian mixture model, and/or artifacts are reduced from the low-resolution video stream using morphological mixing.

As further shown in FIG. 7, the series of acts 700 includes act 720 of detecting a moving object within an alert zone of the thermal video stream. For instance, in some implementations, act 720 involves detecting the moving object within the tracking zone of the thermal video stream by comparing image changes between the first frame of the thermal video stream and the second frame of the thermal video stream. In some implementations, act 720 includes tracking the moving object within a tracking zone of the thermal video stream, where the tracking zone encompasses the alert zone.

In one or more implementations, act 720 includes generating a bounding box around the moving object within the thermal video stream, determining that the moving object corresponds to a person, assigning a first object identifier to the moving object, and associating an alert zone counter with the moving object, where the first object identifier and the alert zone counter are included in the set of tracking parameters associated with the moving object. In some implementations, act 720 includes applying a moving average between a set of sequential frames of the thermal video stream to determine a movement parameter of the moving object and determining to track the moving object based on the moving average meeting a movement threshold.

As further shown in FIG. 7, the series of acts 700 includes act 730 of updating a set of parameters associated with the moving object. For instance, in some implementations, act 730 involves updating a set of tracking parameters associated with the moving object based on detecting a moving object within an alert zone of the thermal video stream. In some instances, the mast captured in the thermal video stream creates a blind spot that prevents a full field of view (FOV) surrounding the mobile security unit. In some cases, the set of tracking parameters associated with the moving object includes movement speed and movement direction (e.g., movement direction, speed, and/or velocity). In various instances, the moving object is tracked based on the movement speed and movement direction when the moving object is occluded within the thermal video stream.

In various implementations, act 730 includes incrementing an alert zone counter associated with the moving object for each instance the moving object is detected within the alert zone, where the alert zone counter is included in the set of tracking parameters associated with the moving object. In some implementations, act 730 includes pausing the alert zone counter from incrementing when the moving object exits the alert zone of the thermal video stream, and resuming incrementing the alert zone counter when the moving object re-enters the alert zone of the thermal video stream, where the set of tracking parameters is maintained for the moving object while the moving object remains within the tracking zone. In some instances, detecting the moving object within the alert zone of the thermal video stream and determining that the first alert threshold is met is performed on a computing device located locally on the mobile security unit.

As further shown in FIG. 7, the series of acts 700 includes act 740 of comparing the set of parameters to alert conditions to determine that an alert threshold is met. For instance, in example implementations, act 740 involves comparing the set of tracking parameters to a set of alert conditions to determine that a first alert threshold is met. In one or more implementations, comparing the set of tracking parameters to the set of alert conditions includes comparing the alert zone counter to an alert zone timer threshold to determine that the first alert threshold is met.

In some implementations, the set of alert conditions includes a first set of alert conditions having a first alert zone counter threshold, where the first set of alert conditions corresponds to the mobile security unit being located in a sterile environment, and a second set of alert conditions having a second alert zone counter threshold where the second set of alert conditions corresponds to the mobile security unit being located in a non-sterile environment. In some instances, the first alert zone counter threshold is shorter than the second alert zone counter threshold.

In one or more implementations, the set of alert conditions includes a first set of alert conditions having a first alert zone counter threshold, where the first set of alert conditions corresponds to a higher amount of pedestrian traffic, and a second set of alert conditions having a second alert zone counter threshold, where the second set of alert conditions corresponds to a lower amount of pedestrian traffic than the first set of alert conditions. In various implementations, the second alert zone counter threshold is shorter than the first alert zone counter threshold.

In various implementations, the mobile security unit includes a set of detection sensors, including a noise detection sensor, a motion detection sensor, and a movement detection sensor. In addition, the set of tracking parameters associated with the moving object includes detection parameters from the set of detection sensors, and/or determining that the first alert threshold is met is based on a detection parameter from the detection parameters meeting a corresponding detection parameter threshold from the set of alert conditions.

As further shown in FIG. 7, the series of acts 700 includes act 750 of sending an alert indication to activate an alarm response based on the alert threshold being met. For instance, in example implementations, act 750 involves sending a first alert indication to an alert system to activate a first set of alarm responses based on the first alert threshold being met. In various implementations, act 750 includes comparing the set of tracking parameters to an additional set of alert conditions to determine that a second alert threshold is met and sending a second alert indication to the alert system to activate a second set of alarm responses based on the second alert threshold being met. In one or more implementations, the second alert threshold is met after the first alert threshold has been met, and the second set of alarm responses is more intrusive than the first set of alarm responses.

In various implementations, the mobile security unit also includes a set of output devices, including a light, a speaker, and an additional camera. In some implementations, the mobile security unit includes a wireless communication unit for providing security alerts to a cloud computing system. In some instances, the first set of alarm responses includes causing the mobile security unit to modify the illumination of a light coupled to the mobile security unit, modify a blinking pattern of the light coupled to the mobile security unit, modify a color display of the light coupled to the mobile security unit, sound an audible message conveyed via a speaker coupled to the mobile security unit, and/or redirect an optical camera coupled to the mobile security unit to capture images of the moving object.

In some implementations, the thermal video stream includes a specialized tracking zone within the alert zone corresponding to a component of the mobile security unit. In some implementations, the thermal video stream is associated with a set of specialized alert conditions that, when met by the set of tracking parameters associated with the moving object, causes a specialized alert indication to activate a specialized set of alarm responses. In some implementations, the specialized set of alarm responses is more intrusive than the first set of alarm responses.

FIG. 8 illustrates certain components that may be included within a computer system 800. The computer system 800 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 800 represents one or more of the client devices, server devices, or other computing devices described above. For example, the computer system 800 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 800 includes a processing system including a processor 801. The processor 801 may be a general-purpose single- or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 801 may be referred to as a central processing unit (CPU) and may cause computer-implemented instructions to be performed. Although the processor 801 shown is just a single processor in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 805 and the data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during the execution of the instructions 805 by the processor 801.

A computer system 800 may also include one or more communication interface(s) 809 for communicating with other electronic devices. The one or more communication interface(s) 809 may be based on wired communication technology, wireless communication technology, or both. Some examples of the one or more communication interface(s) 809 include a Universal Serial Bus (USB), an Ethernet adapter, a wireless adapter that operates according to an Institute of Electrical and Electronics Engineers (IEEE) 802.11 wireless communication protocol, a Bluetooth® wireless communication adapter, and an infrared (IR) communication port.

A computer system 800 may also include one or more input device(s) 811 and one or more output device(s) 813. Some examples of the one or more input device(s) 811 include a keyboard, mouse, microphone, remote control device, button, joystick, trackball, touchpad, and light pen. Some examples of the one or more output device(s) 813 include a speaker and a printer. A specific type of output device that is typically included in a computer system 800 is a display device 815. The display device 815 used with implementations disclosed herein may utilize any suitable image projection technology, such as liquid crystal display (LCD), light-emitting diode (LED), gas plasma, electroluminescence, or the like. A display controller 817 may also be provided for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For clarity, the various buses are illustrated in FIG. 8 as a bus system 819.

This disclosure describes a subjective data application system in the framework of a network. In this disclosure, a “network” refers to one or more data links that enable electronic data transport between computer systems, modules, and other electronic devices. A network may include public networks such as the Internet as well as private networks. When information is transferred or provided over a network or another communication connection (either hardwired, wireless, or both), the computer correctly views the connection as a transmission medium. Transmission media can include a network and/or data links that carry required program code in the form of computer-executable instructions or data structures, which can be accessed by a general-purpose or special-purpose computer. Combinations of the above are also included within the scope of computer-readable media.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC), and then it is eventually transferred to computer system RAM and/or to less volatile computer storage media (devices) at a computer system. Thus, it should be understood that computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Rather, the described features and acts are disclosed as example forms of implementing the claims.

Those skilled in the art will appreciate that the disclosure may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

What is claimed is:

1. A computer-implemented method for determining proximity threats to one or more mobile security units (MSUs), comprising:
receiving a thermal video stream from a thermal camera coupled near a top end of a mast of a mobile security unit, wherein the thermal video stream provides a top-down view of the mobile security unit;
based on detecting a moving object within an alert zone of the thermal video stream, updating a set of tracking parameters associated with the moving object;
comparing the set of tracking parameters to a set of alert conditions to determine that a first alert threshold is met; and
based on the first alert threshold being met, sending a first alert indication to an alert system to activate a first set of alarm responses.

2. The computer-implemented method of claim 1, wherein the thermal video stream includes:
a tracking zone corresponding to tracking movements of objects moving within the tracking zone, the tracking zone surrounding the alert zone; and
the alert zone surrounding the mobile security unit, the alert zone corresponding to tracking movements of objects near the mobile security unit.

3. The computer-implemented method of claim 2, further comprising:
detecting the moving object within the tracking zone of the thermal video stream by comparing image changes between a first frame of the thermal video stream and a second frame of the thermal video stream;
generating a bounding box around the moving object within the thermal video stream;
determining that the moving object corresponds to a person;
assigning a first object identifier to the moving object; and
associating an alert zone counter with the moving object, wherein the first object identifier and the alert zone counter are included in the set of tracking parameters associated with the moving object.

4. The computer-implemented method of claim 3, further comprising:
applying a moving average between a set of sequential frames of the thermal video stream to determine a movement parameter of the moving object; and
determining to track the moving object based on the moving average meeting a movement threshold.

5. The computer-implemented method of claim 4, further comprising:
pausing the alert zone counter from incrementing when the moving object exits the alert zone of the thermal video stream; and
resuming incrementing the alert zone counter when the moving object re-enters the alert zone of the thermal video stream, wherein the set of tracking parameters is maintained for the moving object while the moving object remains within the tracking zone.

6. The computer-implemented method of claim 4, wherein comparing the set of tracking parameters to the set of alert conditions includes comparing the alert zone counter to an alert zone timer threshold to determine that the first alert threshold is met.

7. The computer-implemented method of claim 1, wherein the set of alert conditions includes:
a first set of alert conditions having a first alert zone counter threshold, the first set of alert conditions corresponding to the mobile security unit being located in a sterile environment; and
a second set of alert conditions having a second alert zone counter threshold, the second set of alert conditions corresponding to the mobile security unit being located in a non-sterile environment, wherein the first alert zone counter threshold is shorter than the second alert zone counter threshold.

8. The computer-implemented method of claim 1, wherein the set of alert conditions includes:
a first set of alert conditions having a first alert zone counter threshold, the first set of alert conditions; and
a second set of alert conditions having a second alert zone counter threshold, the second set of alert conditions corresponding to a lower amount of pedestrian traffic, wherein the second alert zone counter threshold is shorter than the first alert zone counter threshold.

9. The computer-implemented method of claim 1, wherein:
the mobile security unit includes a set of detection sensors including a noise detection sensor, a motion detection sensor, and a movement detection sensor;
the set of tracking parameters associated with the moving object includes detection parameters from the set of detection sensors; and
determining that the first alert threshold is met is based on a detection parameter from the detection parameters meeting a corresponding detection parameter threshold from the set of alert conditions.

10. The computer-implemented method of claim 1, wherein the first set of alarm responses includes causing the mobile security unit to at least one of:
modify illumination of a light coupled to the mobile security unit;
modify a blinking pattern of the light coupled to the mobile security unit;
modify a color display of the light coupled to the mobile security unit;
sound an audible message conveyed via a speaker coupled to the mobile security unit; or
redirect an optical camera coupled to the mobile security unit to capture images of the moving object.

11. The computer-implemented method of claim 1, further comprising:
comparing the set of tracking parameters to an additional set of alert conditions to determine that a second alert threshold is met; and
based on the second alert threshold being met, sending a second alert indication to the alert system to activate a second set of alarm responses,
wherein:
the second alert threshold is met after the first alert threshold has been met; and
the second set of alarm responses is more intrusive than the first set of alarm responses.

12. The computer-implemented method of claim 1, wherein detecting the moving object within the alert zone of the thermal video stream and determining that the first alert threshold is met is performed on a computing device located locally on the mobile security unit.

13. The computer-implemented method of claim 1, wherein:
the mast captured in the thermal video stream creates a blind spot that prevents a full field of view surrounding the mobile security unit;
the set of tracking parameters associated with the moving object includes movement speed and movement direction; and
the moving object is tracked based on the movement speed and movement direction when the moving object is occluded within the thermal video stream.

14. The computer-implemented method of claim 1, wherein:
the thermal video stream includes a specialized tracking zone within the alert zone corresponding to a component of the mobile security unit;
the thermal video stream is associated with a set of specialized alert conditions that, when met by the set of tracking parameters associated with the moving object, causes a specialized alert indication to activate a specialized set of alarm responses; and
the specialized set of alarm responses is more intrusive than the first set of alarm responses.

15. A surveillance system comprising:
a mobile security unit having:
a mast having a top end and a lower end; and
a thermal camera coupled to the top end of a mast, the thermal camera configured to provide a thermal video stream with a top-down view of the mobile security unit; and an onboard computer having:
a processor; and
a computer memory including instructions that, when executed by the processor, cause the surveillance system to carry out operations comprising:
receiving a thermal video stream from the thermal camera;
based on detecting a moving object within an alert zone of the thermal video stream, updating a set of tracking parameters associated with the moving object;
comparing the set of tracking parameters to a set of alert conditions to determine that a first alert threshold is met; and
based on the first alert threshold being met, sending a first alert indication to an alert system to activate a first set of alarm responses.

16. The surveillance system of claim 15, wherein the mobile security unit also includes:
a set of output devices including a light, a speaker, and an additional camera; and
a wireless communication unit for providing security alerts to a cloud computing system.

17. The surveillance system of claim 15, wherein the thermal camera is an infrared thermal imaging camera.

18. The surveillance system of claim 15, wherein:
the thermal video stream includes a low-resolution video stream;
noise is reduced from the low-resolution video stream using a Gaussian mixture model; and
artifacts are reduced from the low-resolution video stream using morphological mixing.

19. A non-transitory computer-readable media having computer instructions stored thereon that, when executed by a processing device of a system, causes the system to perform or control performance of operations comprising:
receiving a thermal video stream from a thermal camera coupled near a top end of a mast of a mobile security unit, wherein the thermal video stream provides a top-down view of the mobile security unit;
based on detecting a moving object within an alert zone of the thermal video stream, updating a set of tracking parameters associated with the moving object;
comparing the set of tracking parameters to a set of alert conditions to determine that an alert threshold is met; and
based on the alert threshold being met, sending an alert indication to an alert system to activate a set of alarm responses.

20. The non-transitory computer-readable media of claim 19, the operations further comprising:
tracking the moving object within a tracking zone of the thermal video stream, the tracking zone encompassing the alert zone;
incrementing an alert zone counter associated with the moving object for each instance the moving object is detected within the alert zone, the alert zone counter being included in the set of tracking parameters associated with the moving object; and
sending the alert indication when the alert zone counter meets an alert zone timer threshold.
